(19) United States
(12) Patent Application Publication
(10) Pub. No.: US 2026/0136392 A1
(43) Pub. Date: May 14, 2026

(54) COORDINATED BEAMFORMING (CoBF) SOUNDING FRAME EXCHANGES

(71) Applicant: NXP USA, Inc., Austin, TX (US)

(72) Inventors: Hari Ram Balakrishnan, Chennai (IN); Liwen Chu, San Ramon, CA (US); Rui Cao, Sunnyvale, CA (US); Sudhir Srinivasa, Los Gatos, CA (US); Hongyuan Zhang, Fremont, CA (US)

(21) Appl. No.: 19/388,573

(22) Filed: Nov. 13, 2025

Related U.S. Application Data
(60) Provisional application No. 63/743,251, filed on Jan. 9, 2025.

(30) Foreign Application Priority Data
Nov. 13, 2024 (IN) 202441087577

(51) Int. Cl. H04W 74/0816; H04B 7/06; H04L 5/00; H04W 24/10

(52) U.S. Cl. CPC H04W 74/0816; H04B 7/0617; H04L 5/0048; H04W 24/10

(57) ABSTRACT

Methods and apparatus are described for performing a coordinated beamforming (CoBF) sounding frame exchange between a sharing access point (AP), a shared AP, and stations of a wireless network. The sharing AP performs a pre-CoBF sounding frame exchange with a shared AP during a transmit opportunity (TXOP). The frame exchange includes establishing a first portion of the TXOP for performing a first sounding frame exchange between the sharing AP, the shared AP, and a first station (STA) associated with the sharing AP, and scheduling a second portion of the TXOP for performing a second sounding frame exchange between the shared AP, the sharing AP, and a second station (STA) that is associated with the shared AP. In an example, the pre-CoBF sounding frame exchange includes transmitting, by the sharing AP, a CoBF Invite frame (e.g., a BSRP Trigger frame) and receiving a responsive CoBF Response frame.

### CROSS REFERENCE TO RELATED APPLICATIONS

The present U.S. Utility Patent Application claims priority pursuant to 35 U.S.C. § 119(a) to Indian Provisional Patent Application Number 202441087577, entitled “CBF SOUNDING FRAME EXCHANGES”, filed Nov. 13, 2024, the contents of which are incorporated herein by reference in its entirety and made part of the present U.S. Utility Patent Application for all purposes. The present U.S. Utility Patent Application further claims priority pursuant to 35 U.S.C. § 119(e) to U.S. Provisional Application No. 63/743,251, entitled “CBF FRAME EXCHANGE CONSIDERATION—SOUNDING AND FRAME EXCHANGES”, filed Jan. 9, 2025, the contents of which are incorporated herein by reference in its entirety and made part of the present U.S. Utility Patent Application for all purposes.

### TECHNICAL FIELD

This disclosure relates generally wireless communications, and more specifically to coordinated beamforming between devices of a wireless network.

### BACKGROUND

Wireless local area networks (WLANs) have evolved rapidly over the past couple of decades, including WLANs that conform to the Institute of Electrical and Electronics Engineers (IEEE) 802.11 family of standards. A typical 802.11-based WLAN may be formed by one or more access points (APs) that provide a shared wireless communication medium for servicing a number of client devices or stations (STAs). In particular, an AP manages a Basic Service Set (BSS) that is identified by a Basic Service Set Identifier (BSSID) and advertised by the AP. The AP periodically broadcasts beacon frames to enable STAs within wireless range of the AP to establish and maintain communication links with the AP.

In such WLANs, an AP transmits data within a transmit opportunity (TXOP) after it has gained contention for a wireless medium. In general, a TXOP is a designated time duration for which the AP can transmit frames without contention, essentially giving it exclusive access to the wireless medium (or channel) for a set duration without needing to compete with other devices in a BSS. For example, an AP can transmit multiple frames during an TXOP without interruption, thereby allowing the AP to support Quality of Service (QoS) for delay sensitive applications such as voice or video. The 802.11be amendment to the 802.11 standard defines protocols that allow an AP to share a service period of the TXOP with client stations for uplink communications with the AP and peer-to-peer (P2P) non-Trigger based frame exchanges. The 802.11be amendment further defines an optional Triggered TXOP sharing (TXS) procedure that allows an AP to allocate a portion of an obtained TXOP to an associated station.

### BRIEF DESCRIPTION OF THE DRAWINGS

FIG. 1 illustrates an example of a multi-link communications system in accordance with embodiments of the present disclosure;

FIG. 2 illustrates an example of wireless local area network (WLAN) including a sharing access point and a shared access point in accordance with embodiments of the present disclosure;

FIG. 3 illustrates an example of a frame exchange sequence for a joint coordinated beamforming (CoBF) sounding procedure performed within a single transmit opportunity (TXOP) in accordance with an embodiment of the present disclosure;

FIG. 4 illustrates an example of a frame exchange sequence for a sequential CoBF sounding procedure in accordance with embodiments of the present disclosure;

FIG. 5A illustrates another example of a frame exchange sequence for a joint CoBF sounding procedure in accordance with embodiments of the present disclosure;

FIG. 5B illustrates another example of a frame exchange sequence for a sequential CoBF sounding procedure in accordance with embodiments of the present disclosure;

FIG. 6 illustrates an example of a frame exchange sequence for a CoBF sounding procedure utilizing a CoBF Sync frame in accordance with embodiments of the present disclosure;

FIG. 7 illustrates another example of a frame exchange sequence for a CoBF sounding procedure utilizing a CoBF Sync frame in accordance with an embodiment of the present disclosure;

FIG. 8 depicts an example of a User Info field format of a BRSP Trigger frame in accordance with embodiments of the present disclosure;

FIG. 9 illustrates an example of a Multi-STA BlockAck frame in accordance with embodiments of the present disclosure;

FIG. 10 is a flow chart illustrating an example method for performing a CoBF sounding frame exchange (e.g., in a single TXOP) in accordance with embodiments of the present disclosure; and

FIG. 11 illustrates an example of a wireless device according to embodiments of the present disclosure.

### DETAILED DESCRIPTION

The various implementations described herein relate to novel methodologies and updated frame formats for performing a coordinated beamforming (CoBF) sounding procedure to determine channel state information. More particularly, novel frame exchange sequences and frame formats are disclosed for negotiating and scheduling a CoBF sounding frame exchange (e.g., such as may be defined in the IEEE 802.11bn amendment to the IEEE 802.11 standard).

In an example, a CoBF sounding frame exchange is performed between a sharing access point (AP), a shared AP, and stations of a wireless network. In this example, the sharing AP performs a pre-CoBF sounding frame exchange with a shared AP during a transmit opportunity (TXOP). The frame exchange includes establishing a first portion of the TXOP for performing a first sounding frame exchange between the sharing AP, the shared AP, and a first station (STA) associated with the sharing AP, and scheduling a second portion of the TXOP for performing a second sounding frame exchange between the shared AP, the sharing AP, and a second station (STA) that is associated with the shared AP. The pre-CoBF sounding frame exchange may include transmitting, by the sharing AP, a CoBF Invite frame (e.g., a modified BSRP Trigger frame) and receiving a CoBF Response frame.

As used herein, the term “non-legacy” may refer to physical layer (PHY) protocol data unit (PPDU) formats and communication protocols conforming with the IEEE 802.11bn amendment to the IEEE 802.11 standard (also referred to as Ultra High Reliability or “UHR” or “Wi-Fi 8”), as well as future generations/amendments. In contrast, the term “legacy” may be used herein to refer to PPDU formats and communication protocols conforming to the IEEE 802.11be (also referred to as Extremely High Throughput or “EHT” or “Wi-Fi 7”) or IEEE 802.11ax (also referred to as High Efficiency or “HE” or “Wi-Fi 6/6E”) amendments to the IEEE 802.11 standard, or earlier generations of the IEEE 802.11 standard, but not conforming to all mandatory features of 802.11bq (and 802.11bn) or future generations of the IEEE 802.11 standard. In some implementations, the frame formats described herein may be configurable to support multiple versions of the IEEE 802.11 standard.

As used herein, the term “sharing AP” refers to an AP which obtains a TXOP and initiates or participates in a TXOP sharing process, and the term “shared AP” refers to an AP that initiates or participates in a TXOP sharing process to obtain a shared portion or time allocation of a TXOP obtained by another AP within its range. Any AP that obtains a TXOP can become a sharing AP.

In general, coordinated beamforming is a multi-AP transmission approach where two or more access points (APs) coordinate their respective beamforming/precoding to increase the reliability and throughput of concurrent transmissions (e.g., of CoBF PPDUs) while suppressing mutual interference. A CoBF sounding frame exchange procedure according to the various embodiments described herein may enable joint (or per-STA) spatial processing across APs such that associated stations (STAs) receive stronger desired signals and less inter-AP interference, leading to improved performance for demanding use cases (e.g., virtual reality (VR), low-latency links, etc.) and in dense overlapping BSS scenarios. In an example of a CoBF transmission, each AP sends a PPDU at the same time (with the PHY fields and preamble aligned to facilitate simultaneous reception) while using coordinated precoding/nulling so that intended stations in each BSS can be served concurrently with reduced inter-BSS interference.

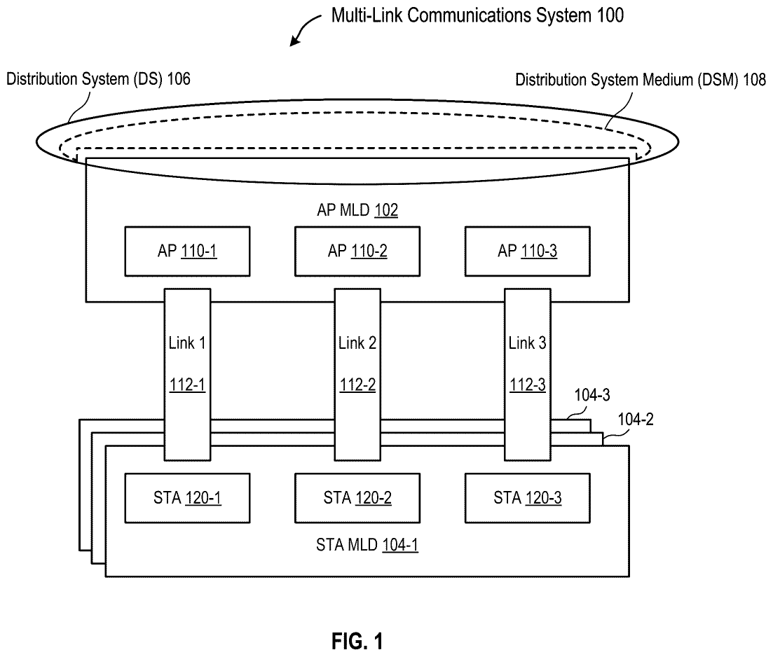

FIG. 1 illustrates an example of a multi-link (ML) communications system 100 in accordance with embodiments of the present disclosure. The illustrated multi-link communications system 100 includes at least one AP multi-link device (MLD) 102 and one or more non-AP multi-link devices, which are, for example, implemented as station (STA) MLDs 104-1, 104-2, and 104-3. The multi-link communications system 100 can be used in various applications, such as industrial applications, medical applications, computer applications, and/or consumer or appliance applications. In the illustrated example, the multi-link communications system is a wireless communications system compatible with an IEEE 802.11 standard. Although the depicted multi-link communications system 100 is shown in FIG. 1 with certain components and described with certain functionality herein, other embodiments of the multi-link communications system 100 may include fewer or more components to implement the same, less, or more functionality. For example, although the multi-link communications system 100 shown in FIG. 1 includes the AP MLD 102 and the STA MLDs 104-1, 104-2, and 104-3, in other embodiments, the multi-link communications system includes other multi-link devices, such as multiple AP MLDs and multiple STA MLDs, or a single AP MLD and a single STA MLD. In another example, the multi-link communications system includes more than three STA MLDs and/or less than three STA MLDs. Although the multi-link communications system 100 is shown in FIG. 1 as being connected in a certain topology, the network topology of the multi-link communications system 100 is not limited to the topology shown in FIG. 1.

In the embodiment depicted in FIG. 1, the AP MLD 102 includes multiple radios, implemented as APs 110-1, 110-2, and 110-3. In some embodiments, the AP MLD 102 is an AP multi-link logical device or an AP multi-link logical entity (MLLE). In some embodiments, a common part of the AP MLD 102 implements upper layer Media Access Control (MAC) functionalities that are common to multiple links (e.g., association establishment, reordering of frames, etc.) and a link specific part of the AP MLD 102, i.e., the APs 110-1, 110-2, and 110-3, implement the upper layer functionalities specific to a link and lower layer MAC functionalities (e.g., beaconing, backoff, frame transmission, frame reception, etc.). The APs 110-1, 110-2, and 110-3 may be implemented in hardware (e.g., circuits), software, firmware, or a combination thereof. At least one of the APs 110-1, 110-2, or 110-3 may be fully or partially implemented as an integrated circuit (IC) device. In some embodiments, the AP MLD and its affiliated APs 110-1, 110-2, and 110-3 are compatible with at least one WLAN communications standard (e.g., at least one IEEE 802.11 standard). For example, the APs 110-1, 110-2, and 110-3 may be wireless APs compatible with at least one non-legacy IEEE 802.11 standard.

In some embodiments, an AP MLD (e.g., the AP MLD 102) is connected to a local network (e.g., a local area network (LAN)) and/or to a backbone network (e.g., the Internet) through a wired connection and wirelessly connects to wireless STA MLDs, for example, through one or more WLAN communications standards, such as an IEEE 802.11 standard. In some embodiments, an AP (e.g., the AP 110-1, the AP 110-2, and/or the AP 110-3) includes at least one antenna, at least one transceiver operably connected to the at least one antenna, and at least one controller operably connected to the corresponding transceiver. In some embodiments, at least one transceiver includes a physical layer (PHY) device. The at least one controller may be configured to control the at least one transceiver to process received packets through the at least one antenna. The at least one controller may be implemented within a processor, such as a microcontroller, a host processor, a host, a digital signal processor (DSP), processing module, or a central processing unit (CPU), which can be integrated in a corresponding transceiver.

Each of the APs 110-1, 110-2, and 110-3 of the AP MLD 104 may operate in different frequency bands. For example, at least one of the APs 110-1, 110-2, or 110-3 of the AP MLD 104 operates in an Extremely High Frequency (EHF) band or the “millimeter wave (mmWave)” frequency band. In some embodiments, the mmWave frequency band is a band of radio wave frequencies between 30 Gigahertz (GHz) and 300 GHz. For example, a mmWave link may operate in a 45 GHz or 60 GHz frequency band. In a specific example, the AP 110-1 may operate in a 6 GHz band (e.g., with a 320 MHz Basic Service Set (BSS) operating channel or other suitable BSS operating channel), the AP 110-2 may operate in a 2.4/5 GHz band (e.g., with a 20/40/80/160 MHz BSS operating channel or other suitable BSS operating channel), and the AP 110-3 may operate in a 60 GHz band (e.g., with a 160 MHz BSS operating channel or other suitable BSS operating channel).

In the illustrated embodiment, the AP MLD is connected to a distribution system (DS) 106 through a distribution system medium (DSM) 108. The distribution system (DS) 106 may be a wired network or a wireless network that is connected to a backbone network such as the Internet. The DSM 108 may be a wired medium (e.g., Ethernet cables, telephone network cables, or fiber optic cables) or a wireless medium (e.g., infrared, broadcast radio, cellular radio, or microwaves). Although the AP MLD 102 is shown in FIG. 1 as including three APs, other embodiments of the AP MLD 102 may include fewer than three APs or more than three APs. In addition, although some examples of the DSM 108 are described, the DSM 108 is not limited to the examples described herein.

In the embodiment depicted in FIG. 1, the STA MLD 104-1 (non-AP MLD) includes radios, which are implemented as multiple non-AP stations (STAs) 120-1, 120-2, and 120-3. The STAs 120-1, 120-2, and 120-3 may be implemented in hardware (e.g., circuits), software, firmware, or a combination thereof. At least one of the STAs 120-1, 120-2, and 120-3 may be fully or partially implemented as an IC device. In some embodiments, the non-AP STAs 120-1, 120-2, and 120-3 are part of the STA MLD 104-1, such that the STA MLD may be a communications device that wirelessly connects to an AP MLD, such as, the AP MLD 102. For example, the STA MLD 104-1 (e.g., at least one of the non-AP STAs 120-1, 120-2 or 120-3) may be implemented in a laptop, a desktop computer, a mobile phone, or other communications device that supports at least one WLAN communications standard. In some embodiments, the STA MLD and its affiliated STAs 120-1, 120-2, and 120-3 are compatible with at least one IEEE 802.11 standard. In an example, each of the non-AP STAs 120-1, 120-2, and 120-3 includes at least one antenna, at least one transceiver operably connected to the at least one antenna, and at least one controller connected to the corresponding transceiver. The at least one transceiver may include a PHY device. The at least one controller can be configured to control the at least one transceiver to process received packets through the at least one antenna. In some embodiments, the at least one controller is implemented by a processor, such as a microcontroller, a host processor, a host, a DSP, processing module, or a CPU, which can be integrated in a corresponding transceiver. In an example, the STA MLD has one MAC data service interface. In another example, a single address is associated with the MAC data service interface and is used to communicate on the DSM 108. In some embodiments, the STA MLD 104-1 implements a common MAC data service interface and the non-AP STAs 120-1, 120-2, and 120-3 implement a lower layer MAC data service interface.

In an example, the AP MLD 102 and/or the STA MLDs 104-1, 104-2, and 104-3 identify which communications links support the multi-link operation during a multi-link operation setup phase and/or exchanges information regarding multi-link capabilities during the multi-link operation setup phase. In addition, each of the STAs 120-1, 120-2, and 120-3 of the STA MLD may operate in the same frequency band or different frequency bands. For example, at least one of the STAs 120-1, 120-2, or 120-3 of the STA MLD 104-1 operates in the mmWave frequency band (e.g., a 45 GHz or 60 GHz frequency band). In an example, the STA 120-1 may operate in a 6 GHz band (e.g., with a 320 MHz BSS operating channel or other suitable BSS operating channel), the STA 120-2 may operate in a 2.4/5 GHz band (e.g., with a 20/40/80/160 MHz BSS operating channel or other suitable BSS operating channel), and the STA 120-3 may operate in a 60 GHz band (e.g., with a 640 MHz BSS operating channel or other suitable BSS operating channel). Although the STA MLD 104-1 is shown in FIG. 1 as including three non-AP STAs, other embodiments of the STA MLD 104-1 may include fewer than three non-AP STAs or more than three non-AP STAs.

Each of the MLDs 104-2, 104-3 may be the same as or similar to the STA MLD 104-1. For example, the MLD 104-2 and 104-3 include one or multiple non-AP STAs. In some embodiments, each of the non-AP STAs includes at least one antenna, at least one transceiver operably connected to the at least one antenna, and at least one controller connected to the corresponding transceiver. In some embodiments, the at least one transceiver includes a PHY device. The at least one controller can be configured to control the at least one transceiver to process received packets through the at least one antenna. In some embodiments, the at least one controller is implemented by a processor, such as a microcontroller, a host processor, a host, a DSP, a processing module, or a CPU, which can be integrated in a corresponding transceiver.

In the illustrated network, the STA MLD 104-1 communicates with the AP MLD 102 through multiple communications links 112-1, 112-2, 112-3. For example, each of the STAs 120-1, 120-2, 120-3 communicates with an AP 110-1, 110-2, or 110-3 through a corresponding wireless communications link 112-1, 112-2, or 112-3. Although the AP MLD 102 communicates (e.g., wirelessly communicates) with the STA MLD 104-1 through multiple links 112-1, 112-2, 112-3, in other embodiments, the AP MLD 102 may communicate (e.g., wirelessly communicate) with the STA MLD through more than three communications links or less three than communications links. In some embodiments, the wireless communications links in the multi-link communications system include one or more 2.4 GHz, 5 GHz, 6 GHz, 45 GHz and/or 60 GHz links.

In the embodiment depicted in FIG. 1, the communications links 112-1, 112-2, and 112-3 between the AP MLD and the STA MLD 104-1 involve at least one mmWave link. For example, the communications links 112-1, 112-2, and 112-3 between the AP MLD 102 and the STA MLD 104-1 include a mmWave link (e.g., a 45/60 GHz link) between an AP of the AP MLD 102 and an STA of the STA MLD 104-1 operating in a mmWave frequency band (e.g., a 45/60 GHz frequency band) and two non-mmWave links (e.g., 2.4 GHz, 5 GHz, or 6 GHz links) and two mmWave links (e.g., a 45 GHz link and a 60 GHz link) between APs of the AP MLD 102 and STAs of the STA MLD 104-1 operating in non-mmWave frequency bands (e.g., 2.4 GHz, 5 GHz, or 6 GHz frequency bands). In another example, the communications links 112-1, 112-2, and 112-3 between the AP MLD 102 and the STA MLD 104-1 include two mmWave links (e.g., 45/60 GHz links) between APs of the AP MLD 102 and STAs of the STA MLD 104-1 operating in mmWave frequency bands (e.g., 45/60 GHz frequency bands) and one non-mmWave link (e.g., a 2.4 GHz, 5 GHz, or 6 GHz link) between an AP of the AP MLD 102 and an STA of the STA MLD 104-1 operating in a non-mmWave frequency bands (e.g., a 2.4 GHz, 5 GHz, or 6 GHz frequency band).

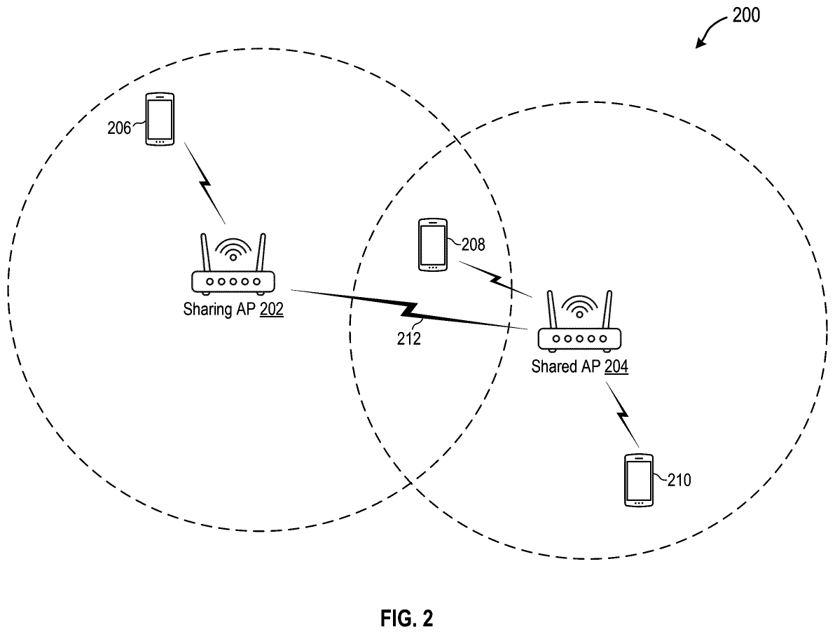

FIG. 2 illustrates an example of wireless local area network (WLAN) 200 including a sharing access point (AP) 202 and a shared AP 204 in accordance with embodiments of the present disclosure. In the illustrated example, a client STA 206 is associated with the sharing AP 202 in a first BSS and client STAs 208 and 210 are associated with the shared AP 204 in a second BSS. One or more of sharing AP 202 and shared AP 204 may be an example of the AP affiliated with an AP MLD 102 of FIG. 1 and one or more of STAs 206, 208 and 210 may be an example of the STA affiliated with a STA MLD 104 of FIG. 1.

In the illustrated example, the sharing AP 202 and the shared AP 204 have varying and overlapping coverage areas (e.g., in a high-density deployment setting) and may communicate directly via a direct wireless link 212. The sharing AP 202 and the shared AP 204 may operate on overlapping but distinct frequencies and bandwidths. In an example, the sharing AP 202 may obtain or secure a TXOP for an operating bandwidth comprising one or more channels, and the shared AP 204 may utilize one or more of the same channels, but may also operate on further channels that do not overlap with the sharing AP's channels.

In an example of CoBF coordinated communications, the sharing AP 202 may obtain a TXOP for a frequency resource (or wireless medium) that is also utilized by shared AP 204, and determine (e.g., via a CoBF sounding agreement negotiation) to share a time allocation of the TXOP with the shared AP 204. In various examples, a shared AP may request a frequency resource from a sharing AP in either a solicited mode (e.g., in response to a polling frame from the sharing AP) or an unsolicited mode. In an example of a solicited mode, a shared AP requests a frequency resource from a sharing AP after receiving a soliciting frame (e.g., a BSRP Trigger frame or other control frame). The solicited frame may be carried, for example, in a PPDU other than a TB PPDU (e.g., a UHR non-TB PPDU). In an example, the solicited frame is a QoS Null frame with a redefined HE control field (which may also be referred to as an HE variant HT control field). In this example, the QoS Null frame does not solicit an acknowledgement (Ack) from the sharing AP. In other examples, the solicited frame is an updated Multi-STA BlockAck frame or newly defined Public Action frame (no Ack) with a newly defined HE control field.

In an example of an unsolicited mode, the shared AP transmits a QoS Null frame with a redefined HE control field to the sharing AP to solicit an Ack from the sharing AP. In another example of an unsolicited mode, the shared AP transmits a newly defined Public Action frame (typically used for Inter-BSS and AP to unassociated-STA communications), having no frame body and a newly defined HE control field, to the sharing AP to solicit an Ack.

In another example, a TXOP sharing announcement (or CoBF sounding agreement announcement) and resource request exchange between the sharing AP and shared AP occurs at the beginning of a TXOP. In this example, the sharing AP announces the time when the shared AP is scheduled through a Trigger frame variant (e.g., an updated BSRP Trigger frame or an updated MU-RTS TXS Trigger frame). The Trigger frame variant may further announce the guaranteed medium time that can be allocated to the shared AP. In a response frame, the shared AP can request more or less medium time than the guaranteed medium time announced by the sharing AP. In this example, the sharing AP may not be able to allocate medium time that is greater than the guaranteed medium time. In any of the foregoing examples, the shared AP 204 may transmit and receive data communications with STA 208 and STA 210 after receiving a time allocation of a TXOP of the sharing AP 202.

A CoBF sounding frame exchange procedure according to the various embodiments described herein enables APs to exchange or derive channel/sounding information and apply beamforming weights (including nulls toward other BSS STAs) such that each STA receives its intended spatial streams while interference from the other AP(s) is suppressed. In various examples, one or more sounding packets (e.g., Null Data Packets or CoBF PPDUs) supply training symbols (e.g., in preambles and/or training (TRN) fields) so STAs can estimate channels for coordinated precoding. The sounding frame exchanges and subsequent feedback exchanges must be scheduled and NAV-protected in order to avoid collisions. In an example, APs may need channel state information (CSI) for both intended and unintended links to achieve effective CoBF operation, and coordinated precoding generally requires relatively fresh cross-link CSI to maintain nulling effectiveness. However, frequent sounding increases overhead. Further, use of a NDPA/NDP/BFRP/CSI sounding frame exchange between a first AP and an associated STA during a TXOP may result in a second AP and its associated STA setting respective inter NAV timers that preclude their use of the TXOP for completing remaining CoBF sounding frame exchanges. The CoBF sounding procedures disclosed herein may reduce such overhead and improve utilization of a TXOP(s). In various examples, a CoBF sounding frame exchange according to the present disclosure may be performed in a single TXOP. In other examples, a first sounding frame exchange occurs in a first TXOP and a second sounding frame exchange occurs in a second TXOP.

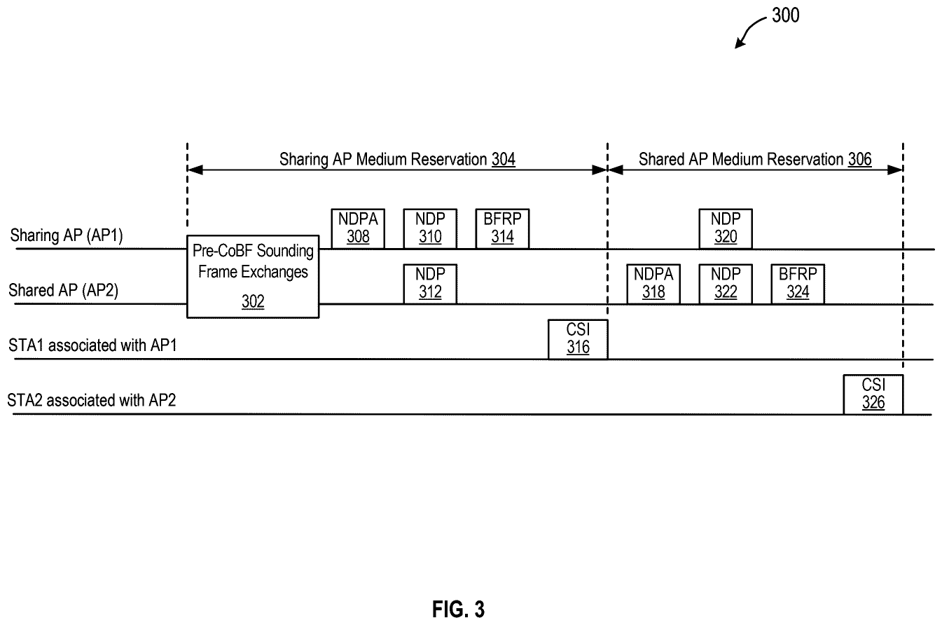

FIG. 3 illustrates an example of a frame exchange sequence for a joint coordinated beamforming (CoBF) sounding procedure 300 performed within a single transmit opportunity (TXOP) in accordance with an embodiment of the present disclosure. In the illustrated example, the CoBF sounding procedure 300 is performed between a sharing AP (AP1), a shared AP (AP2), a STA1 associated with AP1, and a STA2 associated with AP2. In this example, AP1 reserves the medium for a first portion of a TXOP (sharing AP medium reservation 304) and AP2 reserves the medium for a second portion of a TXOP (shared AP medium reservation 306). In an example, AP1 reserves the medium during a pre-CoBF sounding frame exchange 302 until the end of a last CSI packet generated by STA1, following which AP2 reserves the medium until the end of a last CSI packet generated by STA2.

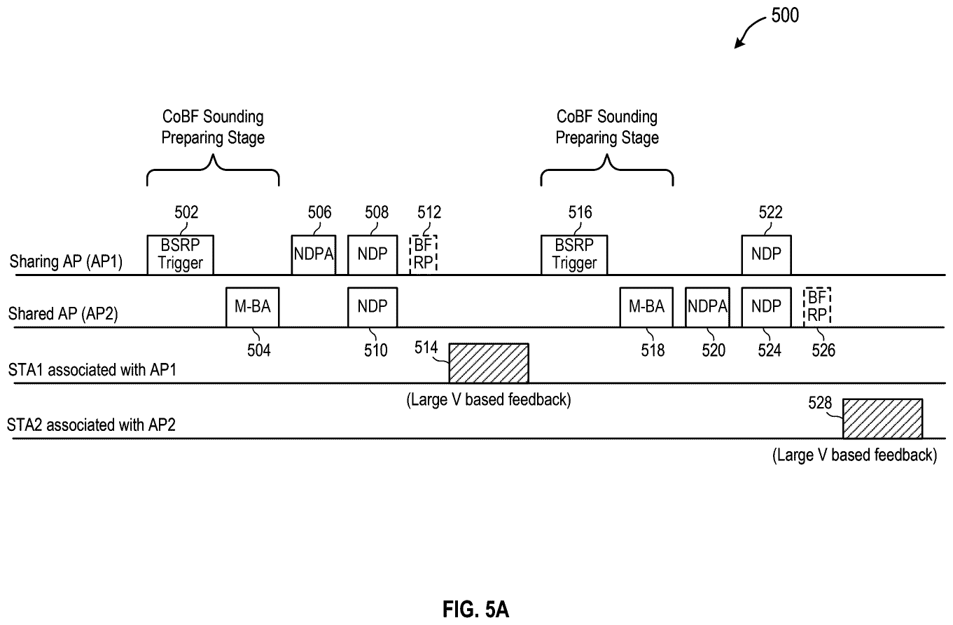

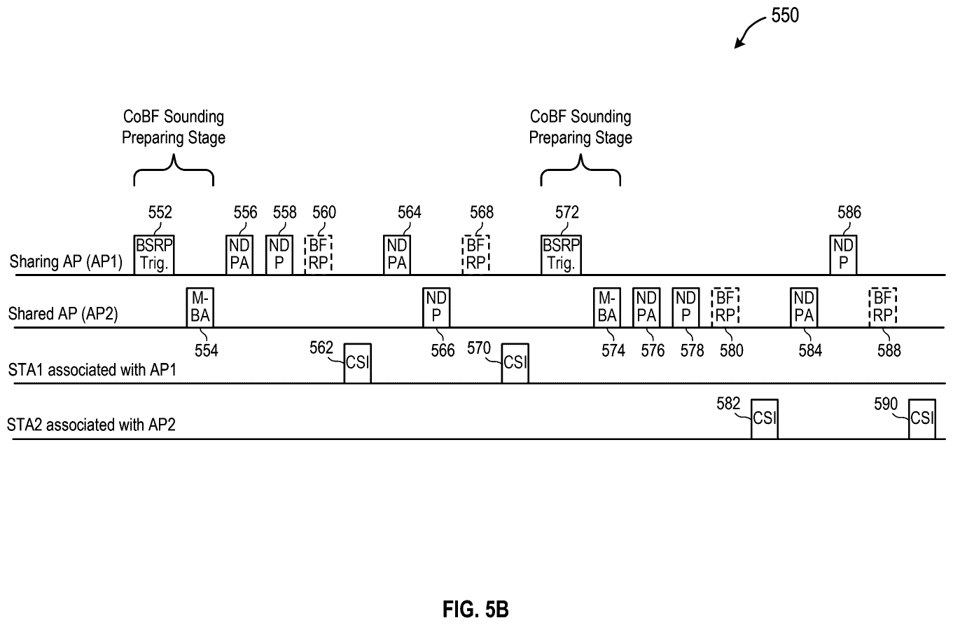

Referring more specifically to FIG. 3, the method of this example includes performing the pre-CoBF sounding frame exchange 302 between (sharing) AP1 and (shared) AP2 during a transmit opportunity (TXOP). The pre-CoBF sounding frame exchange 302 includes establishing a first portion of the TXOP for performing a first sounding frame exchange between AP1, AP2, and STA1. The pre-CoBF sounding frame exchange 302 further includes scheduling a second portion of the TXOP for performing a second sounding frame exchange between AP1, AP2, and STA2. Examples of a pre-CoBF sound frame exchange 302 (which may also be referred to herein as a CoBF sounding preparing stage) are described more fully with reference to FIG. 5A-FIG. 7, and may include a BSRP Trigger frame/Multi-STA BA exchange or a CoBF Invite frame/CoBF Response frame exchange.

In the illustrated example, the first sounding frame exchange includes transmitting, by AP1, a Null Data Packet Announcement frame (NDPA) 308 followed by a first Null Data Packet (NDP) 310 (a “sounding packet”) for reception by STA1. In this example, AP2 jointly transmits a second NDP 312 (i.e., at the same time as NDP 310) for reception by STA1. AP1 next transmits a Beamforming Report Poll (BFRP) Trigger frame 314 to solicit channel state information (CSI) from STA1. In response to the BFRP Trigger frame 314, STA1 transmits CSI 316 to AP1. The CSI 316 of this example is generated based on NDP 310 and NDP 312 (e.g., based on training symbols/fields carried by the NDPs).

As scheduled by the pre-CoBF sounding frame exchange 302, following transmission of CSI 316, AP2 reserves the medium for the second portion of the TXOP. In an example, AP2 begins utilizing the medium a SIFS duration after the end of the first portion of the TXOP, and transmits a NDPA 318 (thereby reserving the medium) followed by a NDP 322. Continuing with this example, AP1 jointly transmits NDP 320 for reception by STA2. AP2 next transmits a BFRP Trigger frame 324 to solicit CSI from STA2. In response to the BFRP Trigger frame 324, STA2 transmits CSI 326 to AP2. The CSI 326 of this example is generated by STA2 based on NDP 310 and NDP 312.

In an alternate embodiment (not separately illustrated), the first sounding frame exchange further includes transmitting, by AP1, a Multi-User Request To Send (MU-RTS) TXS Trigger frame to AP2 following receipt of the CSI 316. In this example, the second portion of the TXOP begins at the end of the MU-RTS TXS Trigger frame, and AP2 transmits a responsive CTS frame to AP1. Continuing with this example, AP2 may initiate the CTS frame as its sharing AP (AP1) based NAV timer will become zero, and the CTS frame can reserve the medium until the end of the last CSI received from STA2.

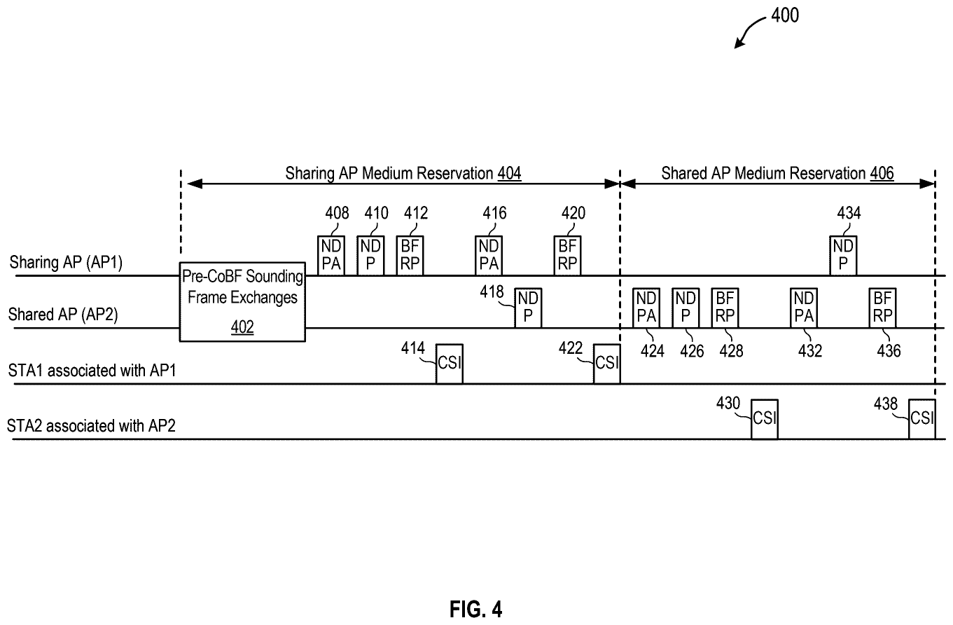

FIG. 4 illustrates an example of a frame exchange sequence for a sequential CoBF sounding procedure 400 performed in a single TXOP in accordance with embodiments of the present disclosure. In the illustrated example, the sequential CoBF sounding procedure 400 is performed between a sharing AP (AP1), a shared AP (AP2), a STA1 associated with AP1, and a STA2 associated with AP2. In this example, AP1 reserves the medium for a first portion of a TXOP (sharing AP medium reservation 404) and AP2 reserves the medium for a second portion of a TXOP (shared AP medium reservation 406). In an example, AP1 reserves the medium during a pre-CoBF sounding frame exchange 402 until the end of a last CSI packet generated by STA1, following which AP2 reserves the medium until the end of a last CSI packet generated by STA2.

The frame exchange sequence of this example includes performing the pre-CoBF sounding frame exchange 402 between AP1 and AP2 during a TXOP, including establishing a first portion of the TXOP for performing a first sounding frame exchange between AP1, AP2, and STA1. The pre-CoBF sounding frame exchange 402 further includes scheduling a second portion of the TXOP for performing a second sounding frame exchange between AP1, AP2, and STA2.

In the illustrated example, the first sounding frame exchange includes transmitting, by AP1, a Null Data Packet Announcement frame (NDPA) 408 followed by a first Null Data Packet (NDP) 410 for reception by STA1. AP1 next transmits a BFRP Trigger frame 412 to solicit CSI 414 from STA1. The illustrated sounding frame exchange sequence further includes transmitting, by AP1, a NDPA 416. In this example, AP2 then transmits a NDP 418 for reception by STA1. AP1 next transmits a BFRP Trigger frame 420 to solicit CSI 422 (based on NDP 418) from STA1. In response to the BFRP Trigger frame 420, STA1 transmits CSI 422 to AP1.

As scheduled by the pre-CoBF sounding frame exchange 402, following transmission of CSI 422, AP2 reserves the medium for the second portion of the TXOP. In an example, AP2 begins utilizing the medium a SIFS duration after the end of the first portion of the TXOP, and transmits a NDPA 424 (thereby reserving the medium) followed by a NDP 426 for reception by STA2. AP2 next transmits a BFRP Trigger frame 428 to solicit CSI 430 (based on NDP 426) from STA2. The illustrated sounding frame exchange sequence further includes transmitting, by AP2, a NDPA 432. In this example, AP1 then transmits a NDP 434 for reception by STA2. AP2 next transmits a BFRP Trigger frame 436 to solicit CSI 438 (based on NDP 434) from STA2. In response to the BFRP Trigger frame 436, STA2 transmits the CSI 438 to AP2.

FIG. 5A illustrates another example of a frame exchange sequence for a joint CoBF sounding procedure 500 in accordance with embodiments of the present disclosure. In the illustrated example, the joint CoBF sounding procedure 500 is performed between a sharing AP (AP1), a shared AP (AP2), a STA1 associated with AP1, and a STA2 associated with AP2. In an example, AP1 reserves the medium during a CoBF sounding preparing stage (similar to a pre-CoBF sounding frame exchange as described above) until the end of a last feedback packet (e.g., a large V based feedback packet 514) generated by STA1, following which AP2 is allocated the medium (via a second CoBF sounding preparing stage) until the end of a last feedback packet generated by STA2 (e.g., a large V based feedback packet 528). In an example, the frame sequence of FIG. 5A occurs during a single TXOP. In another example, frames 502-514 are exchanged during a first TXOP and frames 516-526 are exchanged during a second TXOP.

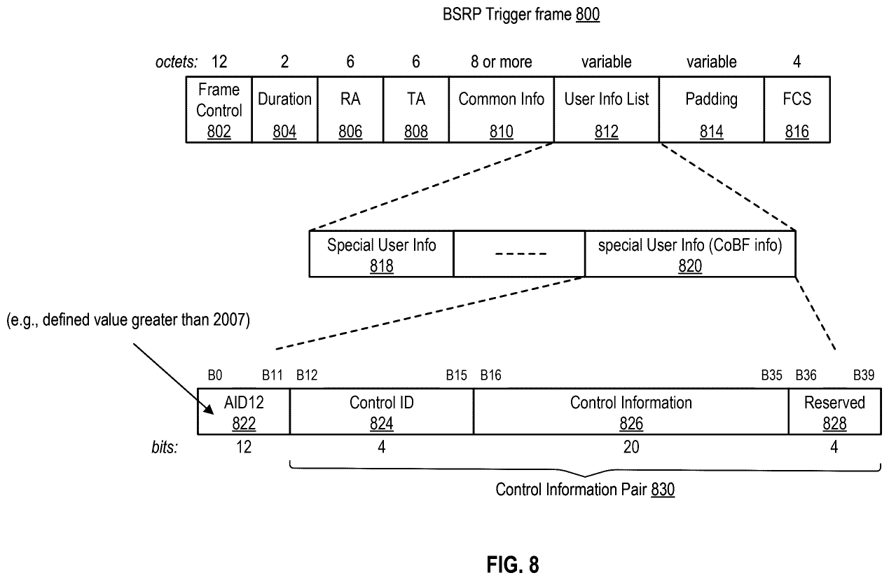

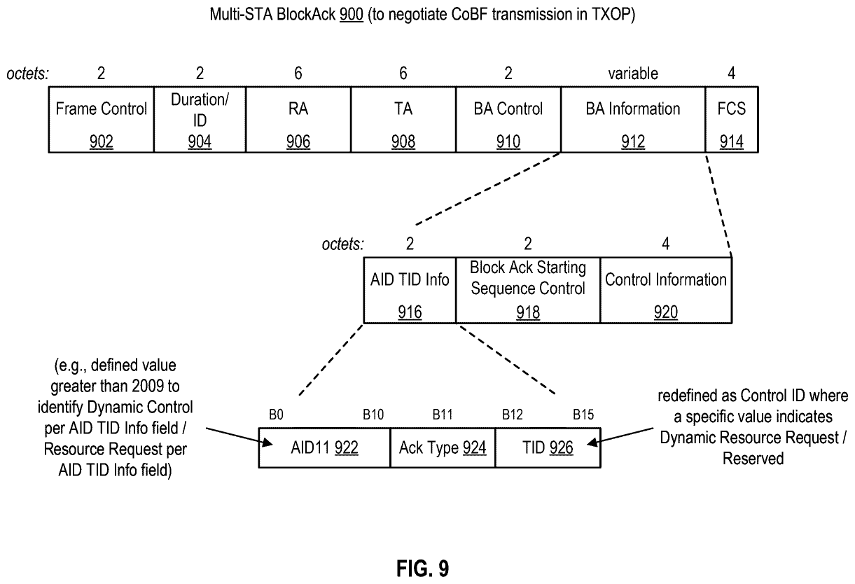

The frame exchange sequence of the illustrated example includes performing a first CoBF sounding preparing stage between AP1 and AP2 in which AP1 transmits a BSRP Trigger frame 502 and AP2 responds with a Multi-STA BlockAck frame 504 to negotiate a first sounding frame exchange. For example, the first CoBF sounding preparing stage may function to check the availability of AP2 and request (via the BSRP Trigger frame 502) that AP2 join the CoBF sounding frame exchange. The BSRP Trigger frame 502 may also poll STA1 (e.g., when STA1 is an eMLSR STA or in a low capability mode). The Multi-STA BlockAck frame 504 indicates whether AP2 will join the CoBF sounding frame exchange, and may further include CoBF related information. Examples of a BSRP Trigger frame 502/516 are described more fully with reference to FIG. 8, and examples of a Multi-STA BlockAck frame 504/518 are described more fully with reference to FIG. 9.

In this example, the first sounding frame exchange includes transmitting, by AP1, a NDPA 506 followed by a first NDP 508 for reception by STA1. In addition, AP2 jointly transmits a second NDP 510 (i.e., at the same time as NDP 508) for reception by STA1. In one embodiment, AP1 may further transmit a BFRP Trigger frame 512 as necessary to solicit channel state information feedback 514 from STA1. In response to NDP 508 (or the BFRP Trigger frame 512), STA1 transmits feedback 514 to AP1. The feedback 514 of this example is generated based on sounding packets NDP 508 and 510.

Continuing with this example, a second CoBF sounding preparing stage is performed to negotiate a sounding frame exchange for gathering channel state information from STA2, including transmitting, by AP1, a BSRP Trigger frame 516. The BSRP Trigger frame 516 may function to poll AP2's NPDA transmission and poll whether AP2 receives sounding feedback correctly. In a further example, the BSRP Trigger frame 516 also polls STA2 if STA2 is an eMLSR STA or is in low capability mode. AP2 responds with a Multi-STA BlockAck frame 518, and further transmits a NDPA 520 (reserving the medium) followed by an NDP 524. In this example, AP1 simultaneously transmits a NDP 522. In one embodiment, AP2 may further transmit a BFRP Trigger frame 526 as necessary to solicit channel state information feedback 528 from STA1.

FIG. 5B illustrates another example of a frame exchange sequence for a sequential CoBF sounding procedure 550 in accordance with embodiments of the present disclosure. In the illustrated example, the joint CoBF sounding procedure 500 is performed between a sharing AP (AP1), a shared AP (AP2), a STA1 associated with AP1, and a STA2 associated with AP2. In an example, the AP1 and AP2 perform a first CoBF sounding preparing stage (via a BSRP Trigger frame 552 and Mult-STA BlockAck frame 554) that functions in an analogous manner to the first CoBF sounding preparing stage described with reference to FIG. 5A.

Following the first CoBF sounding preparing stage, the AP1 of this example transmits a NDPA 556, a NDP 558, and (optionally) a BFRP Trigger frame 560, and receives CSI 562 generated by AP1 based on the NDP 558. Next, AP1 transmits a NDPA 564 followed by a NDP 566 transmitted by AP2. In an example, AP1 further transmits a BFRP Trigger frame 568 (optional) and receives CSI 570 from STA 1 based on the NDP 566.

The illustrated frame exchange sequence further includes a second CoBF sounding preparing stage including transmitting, by AP1, a BSRP Trigger frame 572 that AP2 responds to by transmitting a Multi-STA BlockAck frame 574. In this example, AP2 further transmits a NDPA 576, a NDP 578 and (optionally) a BFRP Trigger frame 580 to solicit CSI 582 from STA2. Following receipt of CSI 582, AP2 transmits NDPA 584 and AP1 transmits NDP 586, and AP2 (optionally) transmits BFRP Trigger frame 588. AP2 then receives CSI 590 (based on NDP 586) from STA2.

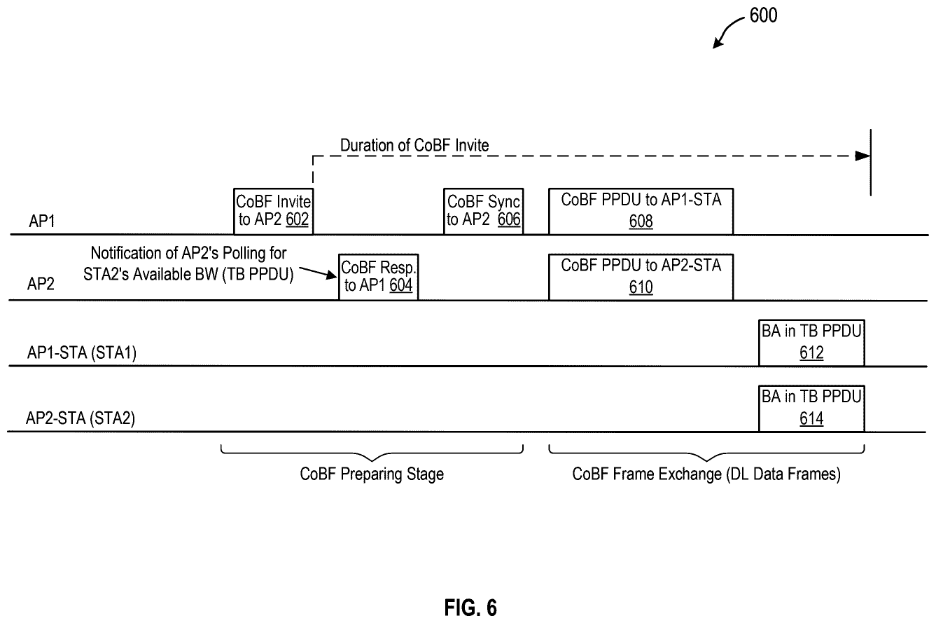

FIG. 6 illustrates an example of a frame exchange sequence for a CoBF sounding procedure 600 utilizing a CoBF Sync frame in accordance with embodiments of the present disclosure. In the illustrated example, the CoBF sounding procedure 600 is performed between a sharing AP (AP1), a shared AP (AP2), a STA1 associated with AP1, and a STA2 associated with AP2.

The frame exchange sequence of this example includes performing a CoBF preparing stage in which AP1 transmits a CoBF Invite frame 602 (e.g., a BSRP Trigger frame) to AP2, and AP2 responds with a CoBF Response frame 604 (e.g., a Multi-STA BlockAck frame). In an example, a CoBF Invite frame may operate in a similar manner as an Initial Control Frame (ICF) and a CoBF Response frame may operate in a similar manner as an Initial Control Response frame (ICR). In the illustrated example, the CoBF Invite frame 602 sets a Duration field to establish a duration that ends following transmission of a BA in TB PPDU from STA1 and STA2.

The CoBF preparing stage of this example further includes a CoBF Sync frame 606 transmitted by AP1 to AP2. Briefly, the CoBF Sync frame 606 may operate to provide a common timing and phase reference, and to provide a coordinated sounding/training/feedback schedule such that AP1 and AP2 can align transmissions. Following the CoBF Sync frame 606, AP1 transmits a CoBF PPDU 608 to STA1 and AP2 concurrently transmits a CoBF PPDU 610 to STA2. In an example, the CoBF PPDU 608 and CoBF PPDU 610 serve a similar function as an NDP and provide training symbols/fields for use in generating CSI data. In the illustrated CoBF frame exchange, STA1 next transmits a BA (in TB PPDU) 612 and STA2 concurrently transmits a BA (in TB PPDU) 614. In this example, CSI data may be subsequently transmitted by STA1 and STA2 (not separately illustrated).

In general, the CoBF Sync frame 606 can be used to synchronize CoBF PPDUs from the sharing AP and the shared AP if a responding PPDU to a BSRP Trigger frame cannot be utilized as the synchronization reference for transmitting CoBF DL PPDUs. Otherwise, the CoBF Sync frame is not required. In an example where a CoBF Sync frame is utilized, the CoBF Sync Frame may carry information such as CoBF PPDU length and the channels allocated to the shared AP for soliciting BAs from STAs associated with the shared AP. In an example, a CoBF Sync frame is addressed to AP2 and the STAs that receive the DL CoBF PPDUs. In this instance, the STAs addressed by the CoBF Sync frame do not transmit responding frames. In a variant, only eMLSR stations, DSO stations, and/or STAs in a low capability mode are addressed by a CoBF Sync frame.

In an example in which a shared AP supports TB PPDU transmissions, a sharing AP may solicit a shared AP's TB PPDU transmission. The sharing AP may further solicit the TB PPDU transmission from a STA(s) associated with the shared AP. In this scenario, the BSS color in the PHY header of a TB PPDU transmitted by the shared AP and its associated STAs can be set to the BSS color used by the sharing AP.

In another example, STA2 may set its basic NAV timer per a received frame at the CoBF preparing stage if a frame (e.g., CoBF Invite frame) from AP1 does not have AP2's BSSID in a RA or TA field of the frame. If the NAV timer is not 0 when STA2 is solicited by a Trigger frame in the CoBF PPDU to transmit a BA in TB PPDU, and the TB PPDU is longer than 128 us, the STA may not be able to transmit the BA since the medium is detected as busy. In order to address this potential issue, the Duration of the CoBF invite frame 602 can indicate an ending time that is no later than end time of the CoBF PPDU that solicits the responding frame from STA2 if STA2 requires CCA checking. In another option, the CS Required field of a Basic Trigger frame carried in the CoBF PPDU is set to 0. In yet another option, the basic NAV timer set AP1/AP2 is ignored when checking the medium busy/idle as required by the basic Trigger in CoBF PPDU.

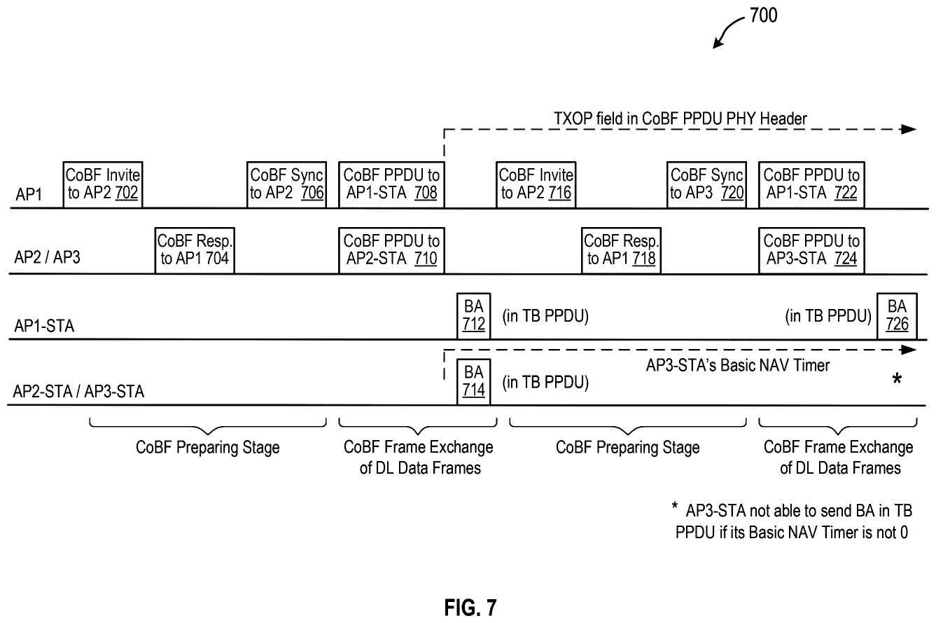

FIG. 7 illustrates another example of a frame exchange sequence for a CoBF sounding procedure 700 utilizing a CoBF Sync frame in accordance with an embodiment of the present disclosure. In the illustrated example, the CoBF sounding procedure 700 is performed between a sharing AP (AP1), a shared AP (AP2), a second shared AP (AP3) a STA1 associated with AP1, a STA2 associated with AP2, and a STA3 associated with AP3.

The frame exchange sequence of this example includes performing a first CoBF preparing stage in which AP1 transmits a CoBF Invite frame 702 (e.g., a BSRP Trigger frame) to AP2, and AP2 responds with a CoBF Response frame 704 (e.g., a Multi-STA BlockAck frame). The CoBF preparing stage of this example further includes a CoBF Sync frame 706 transmitted by AP1 to AP2. In the illustrated example, a first CoBF frame exchange (of DL data frames) includes transmission, by AP1, of a CoBF PPDU 708 to STA1 and simultaneous transmission, by AP2, of CoBF PPDU 710 to STA2. In response to the CoBF PPDUs 708 and 710, STA1 transmits a BA (in TB PPDU) 712 and STA2 concurrently transmits a BA (in TB PPDU) 714.

The frame exchange sequence of this example includes performing a second CoBF preparing stage in which AP1 transmits a CoBF Invite frame 716 to AP2, and AP2 responds with a CoBF Response frame 718. The second CoBF preparing stage of this example further includes a CoBF Sync frame 720 transmitted by AP1 to AP3. In the illustrated example, a second CoBF frame exchange includes transmission, by AP1, of a CoBF PPDU 720 to STA1 and simultaneous transmission, by AP3, of CoBF PPDU 724 to STA3. In response to the CoBF PPDUs 722 and 724, STA1 transmits a BA (in TB PPDU) 726 and STA3 concurrently transmits a BA (in TB PPDU) if basic NAV timer is 0. Various approaches to addressing potential NAV timer issues are described below.

In an example, AP3 and STA3 may set their respective basic NAV timers per the PHY header of CoBF PPDUs to STA1 and STA2. However, a responding frame from AP3 to AP1 and BA from STA3 to AP3 may not be able to be transmitted if CCA checking is required. In a first option to address this potential issue, the Duration field of the CoBF Sync frame 720 and a TXOP field of the CoBF PPDU 722/724 are set to indicate an end time that is no later than a time required by STA3 to perform a medium clear channel assessment (CCA) following the CoBF PPDUs. In a second option, the owner of the frame/PPDU that sets the relevant basic NAV timer is checked. If the owner is the same as the sharing AP, the basic NAV timer is ignored if (1) the Trigger frame is in a CoBF PPDU with the same sharing AP or (2) the responding frame is addressed to the sharing AP.

In a further example, when an AP sets its BSS Color Disabled field to 1, the AP sets a TXOP field of the relevant PHY header to UNSPECIFIED. If a sharing AP or shared AP does not know if a peer AP has its BSS Color Disabled equal to 1, the TXOP field set by the two APs may be different. In a first option to address this potential issue, a CoBF Invite frame and CoBF Response frame carry an indication of whether the transmitter of the frame has BSS Color Disabled equal to 1. If at least one of the APs has BSS Color Disabled equal to 1, the TXOP field in CoBF PPDUs have a TXOP field equal to UNSPECIFIED. In another option, each AP monitors its peer AP's BSS Color Disabled in the peer AP's Beacons. If at least one AP has BSS Color Disabled equal to 1, the TXOP field in the CoBF PPDUs have a TXOP field equal to UNSPECIFIED. In a further option, the CoBF Sync frame decides whether the TXOP field in CoBF PPDUs is set per BSS Color Disabled equal to 1. If the CoBF Sync frame announces BSS Color Disabled equal to 1, the TXOP field in CoBF PPDUs have TXOP field equal to UNSPECIFIED.

FIG. 8 depicts an example of a User Info field format of a BRSP Trigger frame 800 in accordance with embodiments of the present disclosure. In the illustrated example, the BSRP Trigger frame 800 functions as (or is combined with) a CoBF Invite frame that negotiates/schedules a CoBF sounding frame exchange (e.g., in a single TXOP), and carries information such as a suggested CoBF PPDU length under a reference BW and/or a CoBF group (that may include STAs associated with a sharing AP and a shared AP) for a CoBF PPDU(s), whether the shared AP can poll the sharing AP's associated STAs for available bandwidth (this may not be required to simplify the protocol, etc. In another example, the sharing AP announces its associated STA(s) that will join the CoBF sounding frame exchange.

As described more fully below, a sharing AP uses the illustrated BSRP Trigger addressed to a shared AP to provide a Control Information Pair 830 (which may be collectively referred to as “control information”) that includes, for example, an available time allocation of the TXOP, a reference bandwidth (BW), and the start time of the time allocation of the TXOP. In an alternative example, the reference BW is explicitly indicated by the BW of the PPDU carrying BSRP Trigger frame. In another example, the BSRP Trigger frame functions as a sounding frame schedule announcement frame at the beginning of a TXOP. In other examples, a Control Information Pair 830 can be the control information for a single shared AP or multiple shared APs.

In an example, the BSRP Trigger frame is a MAC control frame included in a (CoBF) PPDU transmitted by a sharing AP to a shared AP and one or more client stations, and includes a control information pair(s), resource unit allocation indications and other transmission parameters to be used for transmission of an uplink OFDMA or UL MU MIMO data unit during a transmit opportunity (TXOP). For example, the BSRP Trigger frame may be included in a PPDU that conforms with the IEEE 802.11bn, 802.11be, or other amendment to the IEEE 802.11 standard. In some examples, the BSRP Trigger frame can be used by a sharing AP to solicit a response frame in a TB PPDU (or non-TB PPDU) carrying various control information (e.g., whether to accept a shared TXOP time, and the shared time information) in a control frame.

The BSRP Trigger frame of the illustrated example includes a plurality of fields, including a Frame Control field 802, a Duration field 804, a first address field (e.g., a receiver address (RA) field) 806, a second address field (e.g., a transmitter address (TA) field) 808, a Common Information (“Common Info”) field 810, a User Information (“User Info”) List field 812, a Padding field 814 having zero or more padding bits, and a frame check sequence (FCS) field 816. The number of octets of bits allocated to each field of the BSRP Trigger frame, according to this example, is indicated in FIG. 8 above the corresponding field.

In an example, the frame control field 802 includes a plurality of subfields including a type subfield indicating that the frame is a control frame and a subtype subfield indicating a subtype (e.g., a value of 4 for a BSRP Trigger type) of the frame. In another example, the FCS field 816 is a 32-bit field containing a 32-bit CRC value. The FCS is calculated over all the fields (i.e., “calculation fields”) of the MAC header and the frame body fields. The FCS value may be calculated and appended to a Trigger frame by an AP prior to transmission. Upon receipt of the Trigger frame by a client STA, the client STA can calculate an FCS value for the frame and compare it with the FCS value calculated by the AP. If the two FCS values match, it is assumed that the frame was not corrupted during transmission. If the two FCS values are different, an error is assumed and the frame is discarded. The Padding field 816 is optionally present in BRSP Trigger frame. In an example, the Padding field 816, if present, is at least two octets in length and is set to all 1s.

The Common Info field 810 and User Info List field 812 carry configuration information which may be used by a receiving device to configure a TB PPDU that is transmitted in response to receiving a BSRP Trigger frame unless the BSRP Trigger frame solicits a non-TB PPDU. For example, the User Info List field 812 may include one or more User Information (“User Info”) fields, each of which carries per-user information defining the UL transmission parameters for a respective user to transmit a TB PPDU in its RU, while the Common Info field 810 may carry information that is common to all recipients (e.g., any users associated with the User Info fields of the User Info List field 812) of the Trigger frame.

In the illustrated example, the User Info List field 812 includes a Special User Info field 818 (introduced in 802.11be) followed by a plurality of User Info fields. The Special User Info field 818 is a User Info field that does not carry user specific information for an addressed STA but carries extended common information not provided in the Common Info field. The Special User Info field 818 is distinguished from a User Info field by a special AID12 value (2007). In an example, the Special User Info field 818 includes a PHY Version Identifier subfield value that can be set to identify a Trigger frame as an EHT variant Trigger frame or UHR variant Trigger frame. As specified in 802.11.be, all User Info fields (including the Special User Info field) in the User Info List field of a Trigger frame may have the same length unless the Trigger frame is an MU-BAR Trigger frame.

Each User Info field is associated with a respective AID value. The AID value may be a 12-bit value carried in the AID 12 subfield (in bit positions B0-B11) of a User Info field. In an example, the AID value may uniquely identify a particular STA (or user) in a BSS. Each STA may be assigned a unique AID value, for example, upon associating with the BSS. In addition to an AID12 subfield, each User Info field is defined to include an RU allocation subfield, a UL FEC Coding Type subfield, a UL EHT-MCS subfield, a reserved bit, an SS Allocation subfield, a UL Target Receive Power subfield, a PS160 subfield, and a Trigger Dependent User Info field of variable length. Additional (or modified) subfields may be included in the IEEE 802.11bn amendment to accommodate new features and capabilities while maintaining backwards compatibility with earlier versions of the 802.11 standard.

In this example, the User Info List field 812 of the BSRP Trigger frame further includes a newly defined special User Info field 820 that includes control information for CoBF operations (e.g., to solicit a shared AP's CoBF operation, negotiate a CoBF transmission, etc.). In the illustrated example, bit 0 through bit 11 of the special User Info field 820 include an AID12 subfield 822. The AID12 subfield 822 may include an AID value of a shared AP allocated by the sharing AP to indicate that the special User Info field 820 includes the Control Information pair 830 for the shared AP. In another example, special User Info field 820 immediately follows the User Info field carrying the TB PPDU transmission parameters for the shared AP. In a further example, a special User Info field 820 with specific value in AID12 (e.g. a value >2007) that follows the User Info field for a STA associated with the sharing AP indicates that the following User Info field is for a STA associated with the shared AP.

In this example, the Control Information Pair 830 includes the Control ID subfield 824 and the Control Information subfield 826 provided in bit 12 through bit 39 of the special User Info field 820. The Control Information Pair 830 includes a Control ID subfield 824 (bit 12 through bit 15) and a Control Information subfield 826 (bit 16 through bit 39) having reserved bits 828 (bits 36 through bit 39). A specific value in the Control ID subfield 824 indicates that the Control Information includes information that solicits a responsive CoBF operation (e.g., a polling frame) from a shared AP. In a non-limiting example, the Control ID subfield 824 identifies a CoBF TXOP time sharing polling by a sharing AP that transmits the BSRP Trigger frame to a shared AP that receives the BSRP Trigger frame.

The Control Information subfield 826 of the illustrated example may include information that indicates an advised duration of an intended time allocation of a shared TXOP (referred to in the alternative as medium time), an advised start time of the intended time allocation, a TID whose frames can be exchanged during the shared time, and (optionally) a reference bandwidth of the TXOP. The duration of an intended time allocation may be indicated, for example, in units of microseconds (e.g., 16 us, 32 us, 64 us, etc.), as a number of symbols, as a time slot reference, etc. In an example, the duration of an intended time allocation information is a 9 or 10 bit value in the Control Information subfield 826.

The start time for an intended time allocation may include a relative or absolute time at which the time allocation will become available to a shared AP. In an example, the start time information is indicated as a time difference between the end of the PPDU carrying the BSRP Trigger and the beginning of the intended time allocation. In another example, the start time information is indicated with reference to a timing synchronization function (TSF) timer. In another example, the start time of the intended time allocation information is a 10 bit value (although a greater number of bits or a lesser number of bits may be used) conveyed in units of 16 us or 32 us.

In a further example, a reference bandwidth for the intended time allocation is implicitly indicated by the BW of the PPDU carrying the CoBF Invite frame. If included in the Control Information subfield 826, reference bandwidth information (e.g., a 3 bit value) may include, for example, an indication of a center frequency, a specific bandwidth value, or a combination thereof.

In another example (not separately illustrated), a BSRP Trigger frame is transmitted by the sharing AP to solicit STAs that are associated with the sharing AP and the shared AP, with a Multi-STA BlockAck frame or QoS Null frame as the response frame. The BSRP Trigger frame may further poll the shared AP. In an example, the BSRP Trigger frame triggers an eMLSR STA's radio switch or a DPS STA's switch to high capability mode from low capability mode as required.

In this example, the BSRP Trigger frame may need to account for STA AID collision between a scheduled STA associated with a sharing AP and shared AP, or between a scheduled STA associated with the shared AP and STAs associated with the sharing AP. In a first example, B11 of the AID12 field of the BSRP Trigger frame is utilized to indicate whether a User Info field is for a STA associated with the sharing AP (e.g., B11 equal to 0) or a STA associated with the shared AP (e.g., B11 equal to 1). In another example, a new Trigger type is defined for such polling. For example, the new Trigger type may include a User Info field for a STA associated with the sharing AP that follows a Common Info field or Special User Info field (when it exists) in the Trigger frame. In this example, a special User Info field with specific value in the AID12 field (e.g., a value >2007) that follows the User Info field for the STA associated with the sharing AP indicates that the following User Info field is for a STA associated with the shared AP. The shared AP's ID (e.g., BSS Color) may be carried in the special User Info field.

In another example, a MU-RTS/CTS exchange is used instead of BSRP Trigger/QoS Null exchange. In addition, a CoBF Invite frame and the foregoing BSRP Trigger frame may be the same frame (instead of two frames) when a shared AP supports TB PPPDUs, and the sharing AP is aware of the STAs associated with the shared AP that are to join in a CoBF sounding frame exchange.

FIG. 9 illustrates an example of an updated Multi-STA BlockAck frame including information to negotiate a CoBF transmission. The Multi-STA BlockAck frame 900 of the illustrated example includes a plurality fields, including a Frame Control field 902, a Duration/ID field 904, an RA field 906, a TA field 908, a BA Control field 910, a BA Information field 912, and an FCS field 914. The BA Information field 912 of this example includes a (redefined) Per AID TID Info field 916, a Block Ack Starting Sequence Control field 918, and a Control Information field 920. In this example, a Block Ack Bitmap of field of a legacy Multi-STA BlockAck frame is redefined as the Control Information field 920. The Per AID TID Info field 916 of this example includes an AID11 subfield 922, an Ack Type subfield 924, and a Traffic Identifier (TID) subfield 926.

In the illustrated example, the Multi-STA BlockAck frame 900 functions as CoBF Response frame (such as described above) that negotiates a CoBF sounding frame exchange (e.g., in a single TXOP). The Multi-STA BlockAck frame 900 may carry various information, such as whether a CoBF frame exchange is accepted and if so, a suggested PPDU length under the reference bandwidth. In another example, the Multi-STA BlockAck frame 900 may announce a STA(s) associated with a shared AP that will join the CoBF sounding frame exchange. This may be defined, for example, under the assumption that the sharing AP only announces its associated STA(s) in a CoBF Invite frame. The Multi-STA BlockAck frame 900 may further indicate whether the shared AP accepts a suggestion to poll its associated STA(s) (this may not be required in a simplified protocol).

In a further example, the shared AP may reject a polling request from a sharing AP. Alternatively, the shared AP may always poll its associated STA(s) upon request from a sharing AP. In another example, following a rejection from a shared AP, a sharing AP may perform frame exchanges with its associated STAs in the remaining time of a TXOP, or the sharing AP may begin another CoBF sounding frame exchange. In a frame exchange using a CoBF Invite frame as a soliciting frame, a following BSRP Trigger frame as a soliciting frame can be combined if a shared AP's associated STA is known by the sharing AP.

Referring more specifically the Per AID TID Info field 916 of the Multi-STA BlockAck frame 900, this field As currently defined this field includes an AID value that uniquely identifies a specific STA within a group of STAs being addressed in a multi-station aggregation scenario, and a TID value that specifies a data stream within an STA's traffic. In one embodiment, the illustrated AID11 subfield 922 (bit 0 through bit 10) is redefined to include a special value, such as a defined value greater than 2009, to identify a Dynamic Control Per AID TID Info field (e.g., relating to CoBF operations). In this example, the Ack Type subfield 924 (bit 11) is set to 1 and the TID subfield 926 (bit 12 through bit 15) is redefined as a Control ID subfield where a specific value indicates the resource request. In another variant of this example, 4 bits of a Starting Sequence Number subfield of the Block Ack Starting Sequence Control field 918 are repurposed as the Control ID subfield. In this example, the Fragment Number subfield of the Block Ack Starting Sequence Control field 918 has a specific value to indicate a 4-octet Control Information field.

In a different example, the illustrated AID11 subfield 922 is redefined to include a special value, such as a defined value greater than 2007, to identify a Resource Request Per AID TID Info field. In this example, the Ack Type subfield 924 is set to 1 and the TID subfield 926 is reserved.

In the illustrated example, the Control Information field 920 can include a 4 bit subfield to carry a TID value or CoBF sounding agreement identifier associated with the requested resource. The Control Information field 920 of the illustrated example further includes a 10 bit subfield including a requested medium time (e.g., in units of 32 us, 64 us or 128 us). In another example, this subfield further includes a granularity bit to select a unit of time from two defined units. The Control Information field 920 of this example further includes a 3 bit subfield that carries a reference bandwidth for the requested medium time. In alternate embodiment, the reference bandwidth for the requested medium time can be implicitly indicated by the bandwidth of a soliciting PPDU.

The lengths of the foregoing subfields of the Control Information subfield are provided by way of example, and differing implementations may have subfields including a greater number of bits or a lesser number of bits.

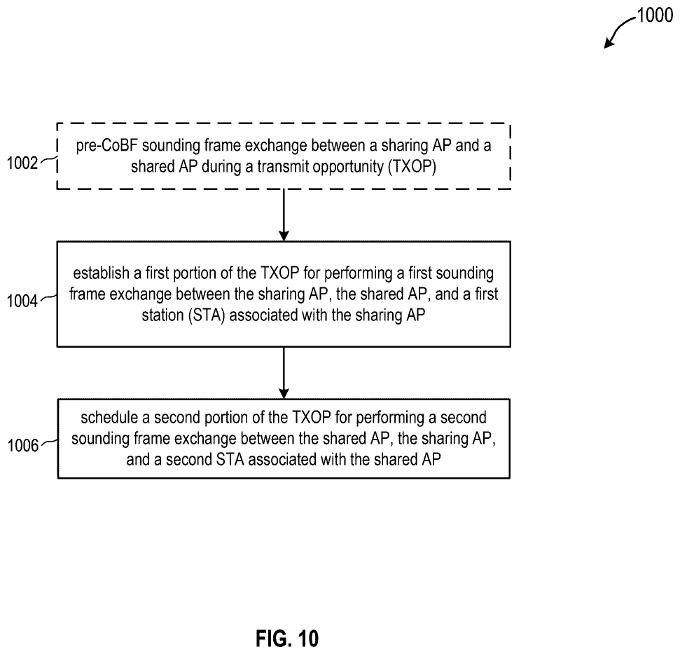

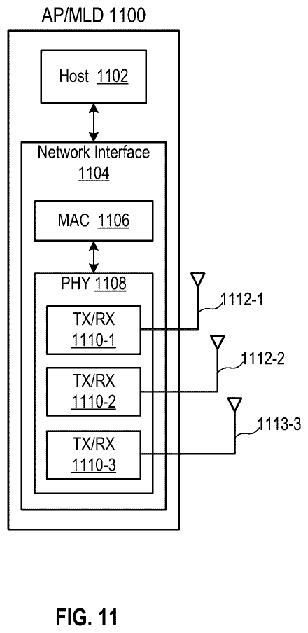

FIG. 10 is a flow chart illustrating an example method 1000 for performing a CoBF sounding frame exchange in accordance with embodiments of the present disclosure. The process 1000 can be performed by a (sharing) AP, such as the AP MLD 102 described with reference to FIG. 1, the sharing AP 202 described with reference to FIG. 2, or the AP/STA 1100 described with reference to FIG. 11. The method 1000 may be utilized, for example, to perform a CoBF sounding frame exchange during a single TXOP.

The method of this example illustrates a pre-CoBF sound frame exchange between a sharing AP and a shared AP (step 1002), which may include the exchange of a CoBF Invite frame and CoBF response frame such as described herein. The method continues at step 1004, where the exchange of frames establishes a first portion of the TXOP for performing a first sounding frame exchange between the sharing AP, the shared AP, and a first station (STA) associated with the sharing AP. The method continues at step 1006, where the exchange of frames schedules a second portion of the TXOP for performing a second sounding frame exchange between the shared AP, the sharing AP, and a second station (STA) associated with the shared AP.

FIG. 11 illustrates an example of a wireless device that is configured as an access point (AP) or station (STA) according to embodiments of the present disclosure. The illustrated AP/STA1100 is configurable to support CoBF sounding frame exchanges according to any of the various embodiments described herein. The AP/STA 1100 of this example includes a host processor 1102 coupled to a network interface device 1104. The network interface device 1104 includes a medium access control (MAC) processing unit 1106 and a physical layer (PHY) processing unit 1108. The PHY processing unit 1108 includes a plurality of transceivers 1110 coupled to a plurality of antennas 1112. Although three transceivers 1110 (1110-1, 1110-2 and 1110-3) and three antennas 1112 (1112-1, 1112-2 and 1112-3) are illustrated in FIG. 1, the AP/STA 1100 includes other suitable numbers (e.g., 1, 2, 4, 5, etc.) of transceivers 1110 and antennas 1112 in other embodiments. In an example, the MAC processing unit 1106 and the PHY processing unit 1108 are configured to operate in compliance with the IEEE 802.11bn amendment to the IEEE 802.11 standard. In an example, the network interface device 1104 includes one or more integrated circuit (IC) devices. In this example, at least some of the functionality of the MAC processing unit 1106 and at least some of the functionality of the PHY processing unit 1108 can be implemented on a single IC device. As another example, at least some of the functionality of the MAC processing unit 1106 is implemented on a first IC device, and at least some of the functionality of the PHY processing unit 1108 is implemented on a second IC device. The AP/STA 1100 may communicate with a plurality of (MLD) client stations and/or APs (not separately illustrated), including both legacy and non-legacy client stations.

In various embodiments, the PHY processing unit 1108 of the AP/STA 1100 is configured to generate data units conforming to a non-legacy communication protocol and having formats described herein. The transceiver(s) 1110 is/are configured to transmit the generated data units via the antenna(s) 1112. Similarly, the transceiver(s) 1110 is/are configured to receive data units via the antenna(s) 1112. The PHY processing unit 1108 of the AP/STA 1100 is configured to process received data units conforming to the non-legacy communication protocol and having formats described herein and to determine that such data units conform to the non-legacy communication protocol.

In an embodiment, when operating in single-user mode, the AP/STA 1100 transmits a data unit to a single client station (DL SU transmission), or receives a data unit transmitted by a single client station (UL SU transmission), without simultaneous transmission to, or by, any other client station. When operating in multi-user mode, the AP/STA 1100 transmits a data unit that includes multiple data streams for multiple client stations (DL MU transmission), or receives data units simultaneously transmitted by multiple client stations (UL MU transmission). For example, in multi-user mode, a data unit transmitted by the AP/STA includes multiple data streams simultaneously transmitted by the AP/STA 1100 to respective client stations using respective spatial streams allocated for simultaneous transmission to the respective client stations and/or using respective sets of OFDM tones corresponding to respective frequency subbands allocated for simultaneous transmission to the respective client stations. In a further example, the AP/STA 1100 may be configured as a multi-link device, such as the AP MLD 102 or STA MLD 104-1 described above with reference to FIG. 1, or the sharing AP 202 or shared AP 204 described above with reference to FIG. 2.

While the innovate aspects of the present disclosure have been generally described in the context of the 802.11bn amendment, and future generations, of the IEEE 802.11 standard (e.g., 802.11bq), a person having ordinary skill in the art will readily recognize that teachings herein may be applied to other wireless networks and standards including, for example, cellular network standards and Bluetooth standards.

The innovative methods and apparatus illustrated in the drawings and described herein provide for efficient coordinated beamforming (CoBF) frame exchanges and related procedures. In an illustrative, non-limiting embodiment, a method for performing a CoBF sounding frame exchange by a sharing access point (AP) of a wireless network is provided. The method includes performing a pre-CoBF sounding frame exchange with a shared AP during a transmit opportunity (TXOP). The pre-CoBF sounding frame exchange includes establishing a first portion of the TXOP for performing a first sounding frame exchange between the sharing AP, the shared AP, and a first station (STA) associated with the sharing AP. The pre-CoBF sounding frame exchange further includes scheduling a second portion of the TXOP for performing a second sounding frame exchange between the shared AP, the sharing AP, and a second station (STA) associated with the shared AP.

The method of this embodiment includes optional aspects. With one optional aspect, the first sounding frame exchange includes transmitting, by the sharing AP, a Null Data Packet Announcement frame (NDPA) and transmitting, by the sharing AP, a first Null Data Packet (NDP) for reception by the first STA. In this optional aspect the sounding frame exchange further includes transmitting, by the sharing AP, a Beamforming Report Poll (BFRP) Trigger frame to solicit channel state information from the first STA, and receiving, from the first STA, channel state information based on the first NDP. With another optional aspect, the first sounding frame exchange further includes transmitting, by the shared AP, a second NDP for reception by the first STA. In this optional aspect, the first NDP and the second NDP are transmitted at the same time, and the channel state information received from the first STA is further based on the second NDP.

In another optional aspect, the first sounding frame exchange further includes transmitting (by the sharing AP) a Multi-User Request To Send (MU-RTS) TXS Trigger frame for receipt by the shared AP following receipt of the channel state information from the first STA. In this optional aspect, the second portion of the TXOP begins at the end of the MU-RTS TXS Trigger frame. In another optional aspect, the first sounding frame exchange further includes: transmitting, by the sharing AP, a second NDPA; transmitting, by the shared AP, a second NDP for reception by the first STA; transmitting, by the sharing AP, a second BFRP Trigger frame; and receiving, from the first STA, channel state information based on the second NDPA.

In another optional aspect, scheduling the second portion of the TXOP for performing the second sounding frame exchange includes scheduling transmission of a Null Data Packet Announcement frame (NDPA) by the shared AP following a Short Interframe Space (SIFS) after the end of the first portion of the TXOP, where the NDPA reserves the medium for the shared AP. In a further optional aspect, performing the pre-CoBF sounding frame exchange with the shared AP includes transmitting, by the sharing AP, a CoBF Invite frame and receiving a responsive CoBF Response frame from the shared AP. In another optional aspect, the CoBF Invite frame is a Buffer Status Report Poll (BSRP) Trigger frame addressed to the shared AP. In yet another optional aspect, the first STA is in an enhanced Multi-Link Single Radio (eMLSR) mode or a low capability mode, and performing the pre-CoBF sounding frame exchange further includes transmitting, by the sharing AP following receipt of the CoBF Response frame, a BSRP Trigger frame that includes a special User Info field addressed to the first STA. In another optional aspect, the CoBF Response frame is a Multi-STA Block Acknowledgement (BA) frame including a BA Information field, where the BA Information field includes information relating to the CoBF sounding frame exchange.

With another illustrative, non-limiting embodiment, a wireless multi-link device (MLD) includes a plurality of wireless transceivers and one or more processing modules operably coupled to the plurality of wireless transceivers. The one or more processing modules are arranged to determine to perform a pre-CoBF sounding frame exchange with a shared AP during a transmit opportunity (TXOP). The pre-CoBF sounding frame exchange includes establishing a first portion of the TXOP for performing a first sounding frame exchange between the sharing AP, the shared AP, and a first station (STA) associated with the sharing AP, and scheduling a second portion of the TXOP for performing a second sounding frame exchange between the shared AP, the sharing AP, and a second station (STA) associated with the shared AP.

This embodiment includes optional aspects. With one optional aspect, the first sounding frame exchange includes transmitting, by the sharing AP, a Null Data Packet Announcement frame (NDPA) and a first Null Data Packet (NDP) for reception by the first STA. This optional aspect further includes transmitting, by the sharing AP, a Beamforming Report Poll (BFRP) Trigger frame to solicit channel state information from the first STA and receiving, from the first STA, channel state information based on the first NDP.

In another optional aspect, the first sounding frame exchange further includes transmitting, by the shared AP, a second NDP for reception by the first STA, where the first NDP and the second NDP are transmitted at the same time and the channel state information received from the first STA is further based on the second NDP. In a further optional aspect, the first sounding frame exchange further includes: transmitting, by the sharing AP, a second NDPA; transmitting, by the shared AP, a second NDP for reception by the first STA; transmitting, by the sharing AP, a second BFRP Trigger frame; and receiving, from the first STA, channel state information based on the second NDPA.

In another optional aspect, scheduling the second portion of the TXOP for performing the second sounding frame exchange includes scheduling transmission of a Null Data Packet Announcement frame (NDPA) by the shared AP following a Short Interframe Space (SIFS) after the end of the first portion of the TXOP. In this optional aspect, the NDPA reserves the medium for the shared AP. In a further optional aspect, performing the pre-CoBF sound frame exchange with the shared AP includes transmitting, by the sharing AP, a CoBF Invite frame and receiving a responsive CoBF Response frame from the shared AP.

With another illustrative, non-limiting embodiment, a method for performing a coordinated beamforming (CoBF) sounding frame exchange by a sharing access point (AP) of a wireless network is provided. The method includes transmitting, by the sharing AP, a CoBF Invite frame addressed to a shared AP. The method further includes receiving, from the shared AP, a CoBF Response frame, where the CoBF Invite frame and the CoBF Response frame establish a beamforming group that includes at least a first STA associated with the sharing AP and a second STA associated with the shared AP. The method further includes transmitting (by the sharing AP) a CoBF Sync frame (addressed to the shared AP) carrying scheduling information for a first CoBF sounding frame exchange. The method further includes transmitting, by the sharing AP, a first CoBF PPDU addressed to the first STA associated with the sharing AP and receiving, from the first STA, channel state information based on the first CoBF PPDU.

The method of this embodiment includes optional aspects. With one optional aspect, the scheduling information for the first CoBF sounding frame exchange instructs the shared AP to transmit a second CoBF PPDU addressed to the first STA, where the first CoBF PPDU and the second CoBF PPDU are transmitted at the same time and the channel state information is further based on the second CoBF PPDU. In another optional aspect, the scheduling information for the first CoBF sounding frame exchange instructs the shared AP to transmit a second CoBF PPDU addressed to the second STA, where the first CoBF PPDU and the second CoBF PPDU are transmitted at the same time.

In another optional aspect, the method of this embodiment includes setting a Duration field of the CoBF Invite frame to have an end time that is no later than the end time of the second CoBF PPDU. In a further optional aspect, a Duration field of the CoBF Sync frame and a TXOP field of the second CoBF PPDU are set to indicate an end time that is no later than a time required by the second STA to perform a medium clear channel assessment (CCA) following the second CoBF PPDU. With another optional aspect, the method further includes determining, by the sharing AP, whether the shared AP is configured to transmit frames with BSS Color disabled and, if disabled, setting a TXOP field of the first CoBF PPDU to unspecified.

To implement various operations described herein, computer program code (i.e., program instructions for carrying out these operations) may be written in any combination of one or more programming languages, including an object-oriented programming language such as Java, Smalltalk, Python, C++, or the like, conventional procedural programming languages, such as the “C” programming language or similar programming languages, or any of machine learning software. These program instructions may also be stored in a computer readable storage medium that can direct a computer system, other programmable data processing apparatus, controller, or other device to operate in a particular manner, such that the instructions stored in the computer readable medium produce an article of manufacture including instructions which implement the operations specified in the block diagram block or blocks. The program instructions may also be loaded onto a processing core, processing circuitry, computer, other programmable data processing apparatus, controller, or other device to cause a series of operations to be performed on the computer, or other programmable apparatus or devices, to produce a computer implemented process such that the instructions upon execution provide processes for implementing the operations specified in the block diagram block or blocks.

As may be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may further be used herein, the term(s) “arranged to”, “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with” includes direct and/or indirect coupling of separate items and/or one item being embedded within another item.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processor”, “processing circuitry”, “processing circuit”, “processing module”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. Further, such a processing device may include a plurality of processing cores or processing domains, which may operate on separate power domains. The processor, processing circuitry, processing circuit, processing module, and/or processing unit may be (or may further include) memory and/or an integrated memory element, which may be a single memory device, a plurality of memory devices, and/or embedded circuitry of another processor, processing circuitry, processing circuit, processing module, and/or processing unit. Such a memory device may be a read-only memory, random access memory, volatile memory, non-volatile memory, static memory, dynamic memory, flash memory, cache memory, and/or any device that stores digital information. Note that if the processor, processing circuitry, processing circuit, processing module, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processor, processing circuitry, processing circuit, processing module, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processor, processing circuitry, processing circuit, processing module, and/or processing unit executes, hard coded and/or operational instructions corresponding to at least some of the steps and/or functions illustrated in one or more of the figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims.

To the extent used, the logic diagram block boundaries and sequence could have been defined otherwise and still perform the certain significant functionality. Such alternate definitions of both functional building blocks and logic diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors/processing cores executing appropriate software and the like or any combination thereof.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” may be used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, a quantum register or other quantum memory and/or any other device that stores data in a non-transitory manner. Furthermore, the memory device may be in a form of a solid-state memory, a hard drive memory or other disk storage, cloud memory, thumb drive, server memory, computing device memory, and/or other non-transitory medium for storing data. The storage of data includes temporary storage (i.e., data is lost when power is removed from the memory element) and/or persistent storage (i.e., data is retained when power is removed from the memory element). As used herein, a transitory medium shall mean one or more of: (a) a wired or wireless medium for the transportation of data as a signal from one computing device to another computing device for temporary storage or persistent storage; (b) a wired or wireless medium for the transportation of data as a signal within a computing device from one element of the computing device to another element of the computing device for temporary storage or persistent storage; (c) a wired or wireless medium for the transportation of data as a signal from one computing device to another computing device for processing the data by the other computing device; and (d) a wired or wireless medium for the transportation of data as a signal within a computing device from one element of the computing device to another element of the computing device for processing the data by the other element of the computing device. As may be used herein, a non-transitory computer readable memory is substantially equivalent to a computer readable memory. A non-transitory computer readable memory can also be referred to as a non-transitory computer readable storage medium.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for performing a coordinated beamforming (CoBF) sounding frame exchange by a sharing access point (AP) of a wireless network, the method comprising:
performing a pre-CoBF sounding frame exchange with a shared AP during a transmit opportunity (TXOP), including:
establishing a first portion of the TXOP for performing a first sounding frame exchange between the sharing AP, the shared AP, and a first station (STA), wherein the first STA is associated with the sharing AP; and
scheduling a second portion of the TXOP for performing a second sounding frame exchange between the shared AP, the sharing AP, and a second station (STA), wherein the second STA is associated with the shared AP.

2. The method of claim 1, wherein the first sounding frame exchange includes:
transmitting, by the sharing AP, a Null Data Packet Announcement frame (NDPA);
transmitting, by the sharing AP, a first Null Data Packet (NDP) for reception by the first STA;
transmitting, by the sharing AP, a Beamforming Report Poll (BFRP) Trigger frame to solicit channel state information from the first STA; and
receiving, from the first STA, channel state information based on the first NDP.

3. The method of claim 2, wherein the first sounding frame exchange further includes:
transmitting, by the shared AP, a second NDP for reception by the first STA, wherein the first NDP and the second NDP are transmitted at the same time, and wherein the channel state information received from the first STA is further based on the second NDP.

4. The method of claim 3, wherein the first sounding frame exchange further includes:
transmitting, by the sharing AP following receipt of the channel state information from the first STA, a Multi-User Request To Send (MU-RTS) TXS Trigger frame for receipt by the shared AP, wherein the second portion of the TXOP begins at the end of the MU-RTS TXS Trigger frame.

5. The method of claim 2, wherein the first sounding frame exchange further includes:
transmitting, by the sharing AP, a second NDPA;
transmitting, by the shared AP, a second NDP for reception by the first STA;
transmitting, by the sharing AP, a second BFRP Trigger frame; and
receiving, from the first STA, channel state information based on the second NDPA.

6. The method of claim 1, wherein scheduling the second portion of the TXOP for performing the second sounding frame exchange includes scheduling transmission of a Null Data Packet Announcement frame (NDPA) by the shared AP following a Short Interframe Space (SIFS) after the end of the first portion of the TXOP, and wherein the NDPA reserves the medium for the shared AP.

7. The method of claim 1, wherein performing the pre-CoBF sounding frame exchange with the shared AP includes:
transmitting, by the sharing AP, a CoBF Invite frame; and
receiving a responsive CoBF Response frame from the shared AP.

8. The method of claim 7, wherein the CoBF Invite frame is a Buffer Status Report Poll (BSRP) Trigger frame addressed to the shared AP.

9. The method of claim 8, wherein the first STA is in an enhanced Multi-Link Single Radio (eMLSR) mode or a low capability mode, and wherein performing the pre-CoBF sounding frame exchange with the shared AP further includes:
transmitting, by the sharing AP following receipt of the CoBF Response frame, a second BSRP Trigger frame, wherein the second BSRP Trigger frame includes a special User Info field addressed to the first STA.

10. The method of claim 7, wherein the CoBF Response frame is a Multi-STA Block Acknowledgement (BA) frame including a BA Information field, wherein the BA Information field includes information relating to the CoBF sounding frame exchange.

11. A sharing access point (AP), comprising:
one or more wireless transceivers; and
one or more processors operably coupled to the one or more wireless transceivers, wherein the one or more processors are arranged to:
perform a pre-CoBF sounding frame exchange with a shared AP during a transmit opportunity (TXOP), including:
establishing a first portion of the TXOP for performing a first sounding frame exchange between the sharing AP, the shared AP, and a first station (STA), wherein the first STA is associated with the sharing AP; and
scheduling a second portion of the TXOP for performing a second sounding frame exchange between the shared AP, the sharing AP, and a second station (STA), wherein the second STA is associated with the shared AP.

12. The sharing AP of claim 11, wherein the first sounding frame exchange includes:
transmitting, by the sharing AP, a Null Data Packet Announcement frame (NDPA);
transmitting, by the sharing AP, a first Null Data Packet (NDP) for reception by the first STA;
transmitting, by the sharing AP, a Beamforming Report Poll (BFRP) Trigger frame to solicit channel state information from the first STA; and
receiving, from the first STA, channel state information based on the first NDP.

13. The sharing AP of claim 12, wherein the first sounding frame exchange further includes:
transmitting, by the shared AP, a second NDP for reception by the first STA, wherein the first NDP and the second NDP are transmitted at the same time, and wherein the channel state information received from the first STA is further based on the second NDP.

14. The sharing AP of claim 11, wherein the first sounding frame exchange further includes:
transmitting, by the sharing AP, a second NDPA;
transmitting, by the shared AP, a second NDP for reception by the first STA;
transmitting, by the sharing AP, a second BFRP Trigger frame; and
receiving, from the first STA, channel state information based on the second NDPA.

15. The sharing AP of claim 11, wherein scheduling the second portion of the TXOP for performing the second sounding frame exchange includes scheduling transmission of a Null Data Packet Announcement frame (NDPA) by the shared AP following a Short Interframe Space (SIFS) after the end of the first portion of the TXOP, and wherein the NDPA reserves the medium for the shared AP.

16. The sharing AP of claim 11, wherein performing the pre-CoBF sound frame exchange with the shared AP includes:
transmitting, by the sharing AP, a CoBF Invite frame; and
receiving a responsive CoBF Response frame from the shared AP.

17. A method for performing a coordinated beamforming (CoBF) sounding frame exchange by a sharing access point (AP) of a wireless network, the method comprising:
transmitting, by the sharing AP, a CoBF Invite frame addressed to a shared AP;
receiving, from the shared AP, a CoBF Response frame, wherein the a CoBF Invite frame and the CoBF Response frame establish a beamforming group that includes at least a first STA associated with the sharing AP and a second STA associated with the shared AP;
transmitting, by the sharing AP, a CoBF Sync frame addressed to the shared AP, the CoBF Sync frame carrying scheduling information for a first CoBF sounding frame exchange;
transmitting, by the sharing AP, a first CoBF PPDU addressed to the first STA associated with the sharing AP; and
receiving, from the first STA, channel state information based on the first CoBF PPDU.

18. The method of claim 17, wherein the scheduling information for the first CoBF sounding frame exchange instructs the shared AP to transmit a second CoBF PPDU addressed to the first STA, wherein the first CoBF PPDU and the second CoBF PPDU are transmitted at the same time, and wherein the channel state information is further based on the second CoBF PPDU.

19. The method of claim 17, wherein the scheduling information for the first CoBF sounding frame exchange instructs the shared AP to transmit a second CoBF PPDU addressed to the second STA, wherein the first CoBF PPDU and the second CoBF PPDU are transmitted at the same time.

20. The method of claim 19, further comprising:
setting a Duration field of the CoBF Invite frame to have an end time that is no later than the end time of the second CoBF PPDU.

21. The method of claim 19, wherein a Duration field of the CoBF Sync frame and a TXOP field of the second CoBF PPDU are set to indicate an end time that is no later than a time required by the second STA to perform a medium clear channel assessment (CCA) following the second CoBF PPDU.

22. The method of claim 17, further comprising:
determining, by the sharing AP, whether the shared AP is configured to transmit frames with BSS Color disabled and, if disabled, setting a TXOP field of the first CoBF PPDU to unspecified.
